(19) United States
(12) Patent Application Publication
(10) Pub. No.: US 2024/0248277 A1
(43) Pub. Date: Jul. 25, 2024

(54) LENS MODULE AND CAMERA MODULE INCLUDING LENS MODULE

(71) Applicant: Samsung Electro-Mechanics Co., Ltd., Suwon-si (KR)

(72) Inventors: Chang Min LEE, Suwon-si (KR); Young Suk KANG, Suwon-si (KR); Yong Joo JO, Suwon-si (KR); Tae Yeon LIM, Suwon-si (KR)

(73) Assignee: Samsung Electro-Mechanics Co., Ltd., Suwon-si (KR)

(21) Appl. No.: 18/519,743

(22) Filed: Nov. 27, 2023

(30) Foreign Application Priority Data
Jan. 25, 2023 (KR) 10-2023-0009463

(51) Int. Cl. G02B 7/02; H04N 23/54; H04N 23/55

(52) U.S. Cl. CPC G02B 7/022; G02B 7/021; H04N 23/54; H04N 23/55

(57) ABSTRACT

A lens module includes a first lens barrel in which at least one lens is disposed and including a first threaded portion and a first stepped portion on an outer circumferential surface of the first lens barrel; and a second lens barrel in which at least one lens is disposed and including a second threaded portion and a second stepped portion on an inner circumferential surface of the second lens barrel, wherein the first lens barrel and the second lens barrel are coupled to each other by fitting the first stepped portion and the second stepped portion to each other and screwing the first threaded portion and the second threaded portion to each other.

### CROSS-REFERENCE TO RELATED APPLICATIONS

This application claims the benefit under 35 USC 119(a) of Korean Patent Application No 10-2023-0009463 filed on Jan. 25, 2023, in the Korean Intellectual Property Office, the entire disclosure of which is incorporated herein by reference for all purposes.

### BACKGROUND

### 1. Field

The present disclosure relates to a lens module and a camera module including a lens module.

### 2. Description of Related Art

Recently, the virtual reality (VR) and augmented reality (AR) market has grown rapidly.

In the field of VR and AR, miniaturization and light weight may be considered important factors.

For example, to miniaturize AR glasses, a size of a display may need to be reduced, and in this process, a size of a lens and a lens barrel may also need to be reduced. However, since optical performance of a miniaturized product may vary greatly due to minute errors generated during assembly, it may be difficult to guarantee acceptable performance at the reduced size.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens module includes a first lens barrel in which at least one lens is disposed and including a first threaded portion and a first stepped portion on an outer circumferential surface of the first lens barrel; and a second lens barrel in which at least one lens is disposed and including a second threaded portion and a second stepped portion on an inner circumferential surface of the second lens barrel, wherein the first lens barrel and the second lens barrel are coupled to each other by fitting the first stepped portion and the second stepped portion to each other and screwing the first threaded portion and the second threaded portion to each other.

The first stepped portion may be formed below the first threaded portion in an optical axis direction of the lens module, and the second stepped portion may be formed below the second threaded portion in the optical axis direction.

A length of the first stepped portion in an optical direction of the lens module may be longer than a length of the first threaded portion in the optical axis direction, and a length of the second stepped portion in the optical axis direction may be longer than a length of the second threaded portion in the optical axis direction.

An outer diameter of the first stepped portion may be smaller than an outer diameter of the first threaded portion, and an inner diameter of the second stepped portion may be smaller than an inner diameter of the second threaded portion.

The first threaded portion may be screwed into the second threaded portion while the first stepped portion is inserted into the second stepped portion.

An optical axis of the at least one lens disposed in the first lens barrel and an optical axis of the at least one lens disposed in the second lens barrel may be aligned with each other by the fitting of the first stepped portion and the second stepped portion to each other.

A distance between the at least one lens disposed in the first lens barrel and the at least one lens disposed in the second lens barrel may be adjusted by the screwing of the first threaded portion and the second threaded portion to each other.

The at least one lens disposed in the first lens barrel may be a plurality of lenses, and the at least one lens disposed in the second lens barrel may be a single lens.

The single lens disposed in the second lens barrel may be a D-cut lens.

One lens among the at least one lens disposed in the second lens barrel may have a largest diameter among the at least one lens disposed in the first lens barrel and the at least one lens disposed in the second lens barrel.

The first lens barrel may include a first support portion configured to support the at least one lens disposed in the first lens barrel on at least one side of the at least one lens disposed in the first lens barrel, and the second lens barrel includes a second support portion configured to support the at least one lens disposed in the second lens barrel on at least one side of the at least one lens disposed in the second lens barrel.

In another general aspect, a camera module includes a lens module including a first lens barrel in which at least one lens is disposed and including a first threaded portion and a first stepped portion on an outer circumferential surface of the first lens barrel; and a second lens barrel in which at least one lens is disposed and including a second threaded portion and a second stepped portion on an inner circumferential surface of the second lens barrel; and an image sensor module coupled to a lower portion of the second lens barrel, wherein the first lens barrel and the second lens barrel are coupled to each other by fitting the first stepped portion and the second stepped portion to each other and screwing the first threaded portion and the second threaded portion to each other.

The image sensor module may include a housing coupled to the lower portion of the lens module; a substrate disposed on the housing; and an image sensor including an imaging plane and disposed on the substrate, the image sensor may be disposed so that a center of the imaging plane is aligned with an optical axis of the lens module, and the substrate may be disposed so that a center of the substrate is closer to one side of the housing relative to the optical axis.

An optical axis of the at least one lens disposed in the first lens barrel and an optical axis of the at least one lens disposed in the second lens barrel may be aligned with each other by the fitting of the first stepped portion and the second stepped portion to each other.

A distance between the at least one lens disposed in the first lens barrel and the at least one lens disposed in the second lens barrel may be adjusted by the screwing of the first threaded portion and the second threaded portion to each other.

In another general aspect, a lens module includes a first lens barrel in which at least one lens is disposed and including a first threaded portion and a first stepped portion on an outer circumferential surface of the first lens barrel; and a second lens barrel in which at least one lens is disposed and including a second threaded portion and a second stepped portion on an inner circumferential surface of the second lens barrel, wherein the first stepped portion is inserted into the second stepped portion to align an optical axis of the at least one lens disposed in the first lens barrel with an optical axis of the at least one lens disposed in the second lens barrel, and the first threaded portion is threaded into the second threaded portion and is rotatable relative to the second threaded portion to correct a focal length of the lens module.

An outer diameter of the first stepped portion may be small enough to enable the first stepped portion to be inserted into the second stepped portion, but large enough to enable an outer surface of the first stepped portion to contact an inner surface of the second stepped portion and maintain an alignment between the optical axis of the at least one lens disposed in the first lens barrel and the optical axis of the at least one lens disposed in the second lens barrel.

The first stepped portion may extends from a lower end of the first threaded portion toward a lower end of the first lens barrel in an optical axis direction of the lens module, and the second stepped portion may extend from a lower end of the second threaded portion toward a lower end of the second lens barrel in the optical axis direction of the lens module.

An outer diameter of the first stepped portion may be smaller than an inner diameter of the second threaded portion and an inner diameter of the second threaded portion.

The at least one lens disposed in the first lens barrel may be a plurality of lenses each having a circular shape, and the at least one lens disposed in the second lens barrel may be a single lens having a D-cut shape.

Other features and aspects will be apparent from the following detailed description, the drawings, and the claims.

### BRIEF DESCRIPTION OF DRAWINGS

FIG. 1 is a perspective diagram illustrating a lens module according to an embodiment.

FIG. 2 is an exploded perspective diagram of the lens module of FIG. 1.

FIG. 3 is a cross-sectional diagram of the lens module of FIG. 1 taken along the line III-III′ in FIG. 1.

FIG. 4 is an exploded diagram of the cross-sectional diagram of FIG. 3.

FIG. 5 is a perspective diagram illustrating a camera module according to another embodiment.

FIG. 6 is a cross-sectional diagram of the camera module of FIG. 5 taken along the line VI-VI′ in FIG. 5.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Embodiments relate to a lens module and a camera module that may be mounted on VR devices and/or AR devices, for example, VR glasses and/or AR glasses.

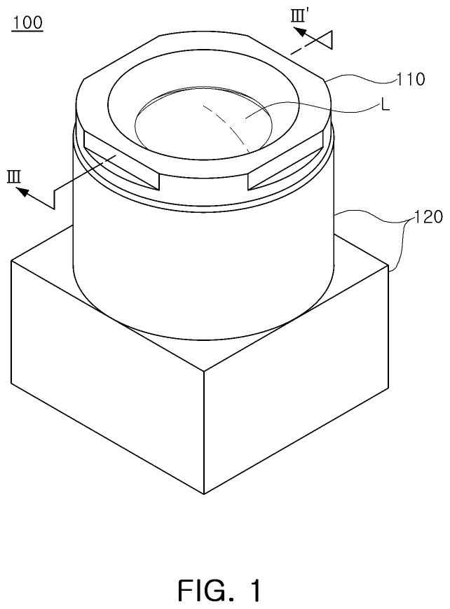

A lens module according to an embodiment will be described with reference to FIGS. 1 to 4.

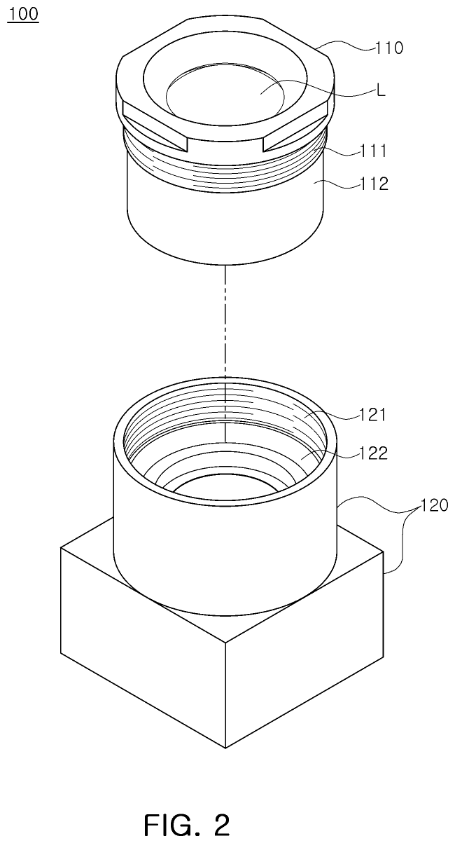

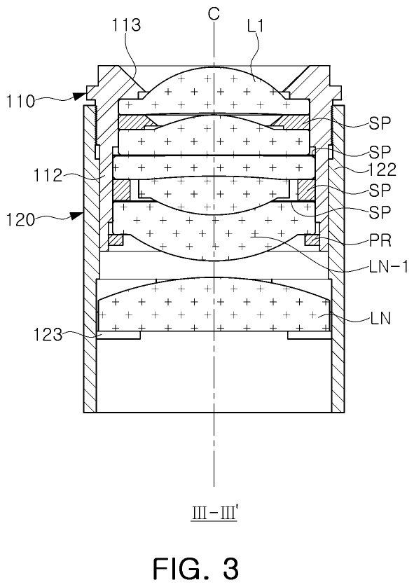

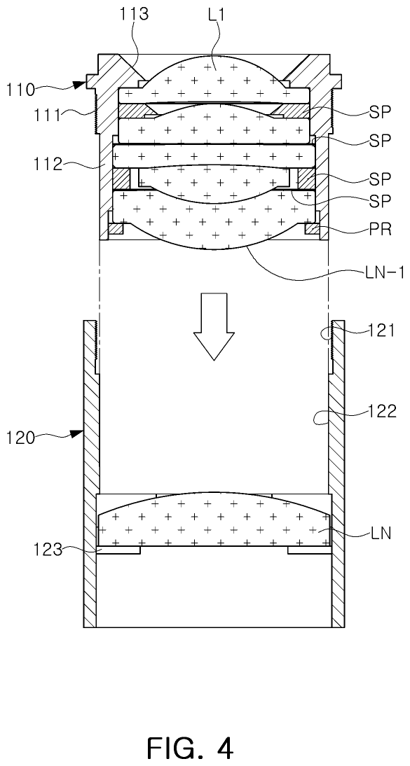

FIG. 1 is a perspective diagram illustrating a lens module according to an embodiment. FIG. 2 is an exploded perspective diagram of the lens module of FIG. 1. FIG. 3 is a cross-sectional diagram of the lens module of FIG. 1 taken along the line III-III′ in FIG. 1. FIG. 4 is an exploded diagram of the cross-sectional diagram of FIG. 3.

Referring to FIGS. 1 to 4, in an embodiment, a lens module 100 may include a first lens barrel 110, a second lens barrel 120, and a plurality of lenses L disposed in the first lens barrel 110 or the second lens barrel 120.

The first lens barrel 110 and the second lens barrel 120 may be coupled to each other. The first lens barrel 110 may be coupled to the second lens barrel 120 in a state in which at least a portion of the first lens barrel 110 is accommodated in the second lens barrel 120.

The first lens barrel 110 and the second lens barrel 120 may each include a hollow portion, and the plurality of lenses L may be disposed in the hollow portions of the first lens barrel 110 and the second lens barrel 120. Specifically, the plurality of lenses L may be disposed in the hollow portion of the first lens barrel 110 and the hollow portion of the second lens barrel 120 in a divided manner. Accordingly, at least one lens L may be disposed in each of the hollow portion of the first lens barrel 110 and the hollow portion of the second lens barrel 120.

For example, the lens module 100 may include N lenses, and an Nth lens LN may be disposed in the hollow portion of the second lens barrel 120. In the hollow portion of the first lens barrel 110, a first lens to an N−1th lens LN−1 may be disposed. The N lenses may be stacked in a direction of an optical axis of the lens module 100 (a Z-axis, denoted by “C” in FIG. 3), and the first lens may be disposed on an uppermost side or an object side with respect to a stacking direction, and the Nth lens may be disposed on a lowermost side or an image side with respect to the stacking direction. The shapes of the lenses illustrated in the drawings may be different from the actual shapes of the lenses.

The plurality of lenses L may include a plurality of lens groups disposed in the first and second lens barrels 110 and 120. For example, the lenses disposed in in the first lens barrel 110 may be a first lens group, and the lens disposed in the second lens barrel 120 may be a second lens group. The lenses of a lens group are fixed to and disposed in the same lens barrel, so distances between the lenses of the lens group are constant. The lenses of different lens groups are fixed to and disposed in different lens barrels, and the different lens barrels are coupled to each other by screwing, so that the distances between the lenses of the different lens groups may vary, as will be described in greater detail later.

Each of the plurality of lenses L may include an optical portion and a flange portion. The optical portion may be configured to refract light reflected from a subject, and the flange portion may be configured to mount the lens L in the lens barrel.

Also, at least a portion of the plurality of lenses L may be D-cut lenses. An optical portion of a D-cut lens may be generally circular, but a portion of the flange portion may be removed to form a “D” shape. For example, the Nth lens LN disposed in the second lens barrel 120 among the plurality of lenses L may be a D-cut lens.

The plurality of lenses L disposed in the first lens barrel 110 and the second lens barrel 120 may have different diameters. Generally, diameters of the plurality of lenses L may increase toward a lower side with respect to the stacking direction, and the diameter of the Nth lens LN disposed in the second lens barrel 120 may be the largest among the plurality of lenses L.

As such, to accommodate the plurality of lenses L having different diameters, the internal surface of the lens barrel may be formed to have steps. For example, an internal surface of the first lens barrel 110 on which the plurality of lenses L are disposed may have steps to accommodate the lenses L having different diameters.

Only the Nth lens LN may be disposed in the second lens barrel 120, but the second lens barrel 120 may also have an internal surface having a step that may be configured to align the optical axes (Z-axis) of the plurality of lenses L, and a further description thereof will be provided later.

The plurality of lenses L may be disposed at predetermined positions in the optical axis (Z-axis) direction. By disposing spacers SP between adjacent lenses in the same lens barrel, distances between the lenses disposed in the same lens barrel among the plurality of lenses L may be maintained at predetermined distances. Distances between the lenses disposed in different lens barrels among the plurality of lenses L may be adjusted by adjusting the distance between the different lens barrels.

That is, in the embodiments, in the first lens barrel 110, spacers SP may be selectively disposed between adjacent lenses in the first lens barrel 110 to maintain predetermined distances between the adjacent lenses in the first lens barrel 110, and the distance between the N−1th lens LN−1 disposed on the lowermost side in the first lens barrel 110 and the Nth lens LN disposed in the second lens barrel 120 may be adjusted by adjusting the distance between the first lens barrel 110 and the second lens barrel 120.

Each lens barrel may include a support portion for supporting a lens L disposed thereon. The support portion may support at least one lens L on at least one side.

The first lens barrel 110 may include a first support portion 113 supporting an object-side surface of the first lens L1. The first support portion 113 may be in contact with the flange portion on the object-side surface of the first lens L1 so that the first support portion 113 may prevent the plurality of lenses L disposed in the first lens barrel 110 including the first lens L1 from being separated from each other and from the first lens barrel 110.

The second lens barrel 120 may include a second support portion 123 for supporting the Nth lens LN. The second support portion 123 may have a stepped shape protruding from a corner portion of the second lens barrel 120 toward the hollow portion in which the Nth lens LN is disposed. For example, the Nth lens LN may be a D-cut lens from which a portion of the flange portion has been removed, and the Nth lens LN may be disposed in the second lens barrel 120 so that the flange portion may be supported by the second support portion 123.

The first lens barrel 110 may have an open lower end, and accordingly the first lens barrel 110 may further include a press-fit ring PR for supporting the N−1th lens LN−1 disposed on the lowermost side of the first lens barrel 110. That is, the plurality of lenses L disposed in the first lens barrel 110 may be supported by the first support portion 113 on an object side and may be supported by the press-fit ring PR on a lowermost side.

As described above, in an embodiment, the first lens barrel 110 and the second lens barrel 120 may be coupled to each other. Specifically, referring to FIGS. 3 and 4, the first lens barrel 110 and the second lens barrel 120 may be coupled to each other by screwing them together.

The first lens barrel 110 and the second lens barrel 120 may be coupled to each other by screwing them together while the first lens barrel 110 is accommodated in the second lens barrel 120. To this end, the first lens barrel 110 may include a first threaded portion 111 on an outer circumferential surface of the first lens barrel 110, and the second lens barrel 120 may include a second threaded portion 121 on an inner circumferential surface of the second lens barrel 120. In an embodiment, since the lens module 100 has a structure in which the first lens barrel 110 and the second lens barrel 120 are coupled to each other through the first and second threaded portions 111 and 121, the fastening method may be simplified and may be easily performed.

Also, as for a method in which the first lens barrel 110 and the second lens barrel 120 are coupled to each other through the first and second threaded portions 111 and 121, the distance between the N−1th lens LN−1 disposed on the lowermost side in the first lens barrel 110 and the Nth lens LN disposed in the second lens barrel 120 may be easily adjusted. The adjustment of the distance may refer to the adjustment of the distance between the first lens group (the first lens to the N−1th lens LN−1) disposed in the first lens barrel 110 and the second lens group (the Nth lens LN) disposed in the second lens barrel 120. In the description below, the adjustment of the distance between the first lens group and the second lens group will be described.

For example, the distance between the first lens group and the second lens group may be adjusted by the number of times the first and second lens barrels 110 and 120 are turned along the first and second threaded portions 111 and 121. Since the first and second threaded portions 111 and 121 have a predetermined pitch, the distance between the first lens group and the second lens group may be precisely adjusted in units of a pitch of the first and second threaded portions 111 and 121.

During the lens assembly process, a thickness of the lens or a distance between the lenses during the assembly process may differ from a predetermined design value, which may affect a focus. However, by disposing the plurality of lenses L in the first lens barrel 110 and the second lens barrel 120 in a divided manner, the focus may be corrected by adjusting the distance between the first and second lens barrels 110 and 120 to change the distance between the first and second lens groups.

In an embodiment, each of the first lens barrel 110 and the second lens barrel 120 may include a first stepped portion 112 and a second stepped portion 122 to compensate for decentering during screw-coupling.

In the first lens barrel 110, the first stepped portion 112 may extend in an optical axis (Z-axis) direction toward the second lens barrel 120. Specifically, the first stepped portion 112 may extend in the optical axis (Z-axis) direction from the lower end portion of the first threaded portion 111, and preferably, a length of the first stepped portion 112 in the optical axis (Z-axis) direction may be longer than a length of the first threaded portion 111 in the optical axis (Z-axis) direction. Also, an outer diameter of the first stepped portion 112 may be smaller than an outer diameter of the first threaded portion 111.

In the second lens barrel 120, the second stepped portion 122 may extend in an optical axis (Z-axis) direction away from the first lens barrel 110. Specifically, the second stepped portion 122 may extend in the optical axis (Z-axis) direction from the lower end portion of the second threaded portion 121, and preferably, a length of the second stepped portion 122 in the optical axis (Z-axis) direction may be longer that a length of the second threaded portion 121 in the optical axis (Z-axis) direction. Also, an inner diameter of the second stepped portion 122 may be smaller than an inner diameter of the second threaded portion 121.

The first stepped portion 112 and the second stepped portion 122 may align optical axes (Z-axes of the first lens group and the second lens group with each other. Specifically, the first lens barrel 110 may be accommodated in the second lens barrel 120 so that the outer circumferential surface of the first stepped portion 112 may be fitted to the inner circumferential surface of the second stepped portion 122. As described above, decentering between the optical axes of the plurality of lenses L may occur due to tolerances generated during processing and assembling the plurality of lenses L, and in an embodiment, the lens barrels 110 and 120 may include the stepped portions 112 and 122 extending in the optical axis (Z-axis) direction to reduce the decentering.

In particular, the first lens barrel 110 and the second lens barrel 120 may be coupled by screwing the first and second threaded portions 111 and 121 to each other while the first stepped portion 112 is inserted into the second stepped portion 122, thereby reducing decentering and tilting that may occur while screwing the first and second threaded portions 111 and 121 to each other.

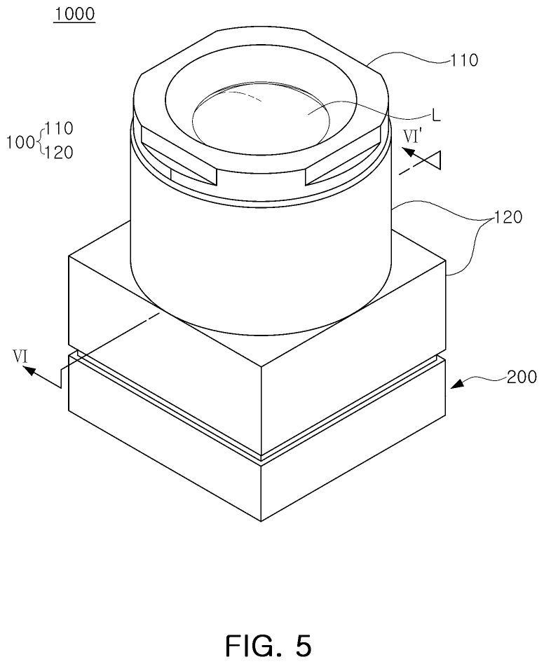

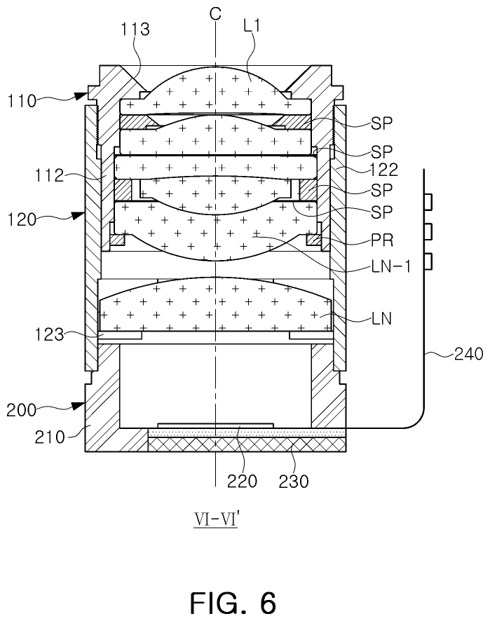

In the description below, a camera module including the lens module described in the aforementioned embodiment will be described with reference to FIGS. 5 and 6.

FIG. 5 is a perspective diagram illustrating a camera module according to an embodiment. FIG. 6 is a cross-sectional diagram of the camera module of FIG. 5 taken along the line VI-VI′ in FIG. 5.

Referring to FIGS. 5 and 6, in an embodiment, a camera module 1000 may include the lens module 100 described in the aforementioned embodiment and an image sensor module 200.

The image sensor module 200 may be coupled to a lower end of the second lens barrel 120. Accordingly, light passing through the plurality of lenses L accommodated in the first and second lens barrels 110 and 120 may be incident to the image sensor module 200. In embodiments, a method of coupling between the lens module 100 and the image sensor module 200 is not limited to any particular method.

The image sensor module 200 may include a housing 210 coupled to the lower end of the second lens barrel 120, an image sensor 220, a substrate 230 on which the image sensor 220 is mounted, and a connector 240 for electrical connection with an external device.

The image sensor 220 may convert light incident through the lens module 100 into an electrical signal. For example, the image sensor 220 may be a charge-coupled device (CCD) or a complementary metal-oxide-semiconductor (CMOS) device. The image sensor 220 may be disposed so that an imaging plane on which an image is formed may oppose the Nth lens LN. Also, a center of the imaging plane may coincide with the optical axis (the Z-axis, denoted by “C” in FIG. 6) of the plurality of lenses L.

In an embodiment, a center of the substrate 230 on which the image sensor 220 is mounted may be disposed closer to one side of the housing 210 than the optical axis (Z-axis). Accordingly, the connector 240 may be exit from the camera module 1000 from the one side of the substrate 230, and a horizontal distortion of the substrate 230 caused by the connector 240 may be prevented. In the drawing, an embodiment is illustrated in which the center of the substrate 230 on which the image sensor 220 is mounted is disposed closer to the right side of the housing 210 than the optical axis (Z-axis), but in another embodiment, a center of the substrate 230 may coincide with the optical axis (Z-axis). That is, the image sensor module 200 may have a symmetrical structure.

According to the aforementioned embodiments, since the first and second lens barrels 110 and 120 include the first and second threaded portions 111 and 121 that enable the distance between the first and second lens groups to be adjusted, even when the lens module and the camera module including the lens module are manufactured in a small size, the lens module and the camera module may have an optical performance close to a designed target value. Also, an optical performance of the lens module 100 may be calibrated in a simplified manner.

While this disclosure includes specific examples, it will be apparent after an understanding of the disclosure of this application that various changes in form an details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a first lens barrel in which at least one lens is disposed and comprising a first threaded portion and a first stepped portion on an outer circumferential surface of the first lens barrel; and
a second lens barrel in which at least one lens is disposed and comprising a second threaded portion and a second stepped portion on an inner circumferential surface of the second lens barrel,
wherein the first lens barrel and the second lens barrel are coupled to each other by fitting the first stepped portion and the second stepped portion to each other and screwing the first threaded portion and the second threaded portion to each other.

2. The lens module of claim 1, wherein the first stepped portion is formed below the first threaded portion in an optical axis direction of the lens module, and
the second stepped portion is formed below the second threaded portion in the optical axis direction.

3. The lens module of claim 1, wherein a length of the first stepped portion in an optical direction of the lens module is longer than a length of the first threaded portion in the optical axis direction, and
a length of the second stepped portion in the optical axis direction is longer than a length of the second threaded portion in the optical axis direction.

4. The lens module of claim 1, wherein an outer diameter of the first stepped portion is smaller than an outer diameter of the first threaded portion, and
an inner diameter of the second stepped portion is smaller than an inner diameter of the second threaded portion.

5. The lens module of claim 1, wherein the first threaded portion is screwed into the second threaded portion while the first stepped portion is inserted into the second stepped portion.

6. The lens module of claim 1, wherein an optical axis of the at least one lens disposed in the first lens barrel and an optical axis of the at least one lens disposed in the second lens barrel are aligned with each other by the fitting of the first stepped portion and the second stepped portion to each other.

7. The lens module of claim 1, wherein a distance between the at least one lens disposed in the first lens barrel and the at least one lens disposed in the second lens barrel is adjusted by the screwing of the first threaded portion and the second threaded portion to each other.

8. The lens module of claim 1, wherein the at least one lens disposed in the first lens barrel is a plurality of lenses, and
the at least one lens disposed in the second lens barrel is a single lens.

9. The lens module of claim 8, wherein the single lens disposed in the second lens barrel is a D-cut lens.

10. The lens module of claim 1, wherein one lens among the at least one lens disposed in the second lens barrel has a largest diameter among the at least one lens disposed in the first lens barrel and the at least one lens disposed in the second lens barrel.

11. The lens module of claim 1, wherein the first lens barrel comprises a first support portion configured to support the at least one lens disposed in the first lens barrel on at least one side of the at least one lens disposed in the first lens barrel, and
the second lens barrel comprises a second support portion configured to support the at least one lens disposed in the second lens barrel on at least one side of the at least one lens disposed in the second lens barrel.

12. A camera module comprising:
a lens module comprising:
a first lens barrel in which at least one lens is disposed and comprising a first threaded portion and a first stepped portion on an outer circumferential surface of the first lens barrel; and
a second lens barrel in which at least one lens is disposed and comprising a second threaded portion and a second stepped portion on an inner circumferential surface of the second lens barrel; and
an image sensor module coupled to a lower portion of the second lens barrel,
wherein the first lens barrel and the second lens barrel are coupled to each other by fitting the first stepped portion and the second stepped portion to each other and screwing the first threaded portion and the second threaded portion to each other.

13. The camera module of claim 12, wherein the image sensor module comprises:
a housing coupled to the lower portion of the lens module;
a substrate disposed on the housing; and
an image sensor comprising an imaging plane and disposed on the substrate,
the image sensor is disposed so that a center of the imaging plane is aligned with an optical axis of the lens module, and
the substrate is disposed so that a center of the substrate is closer to one side of the housing relative to the optical axis.

14. The camera module of claim 12, wherein an optical axis of the at least one lens disposed in the first lens barrel and an optical axis of the at least one lens disposed in the second lens barrel are aligned with each other by the fitting of the first stepped portion and the second stepped portion to each other.

15. The camera module of claim 12, wherein a distance between the at least one lens disposed in the first lens barrel and the at least one lens disposed in the second lens barrel is adjusted by the screwing of the first threaded portion and the second threaded portion to each other.

16. A lens module comprising:
a first lens barrel in which at least one lens is disposed and comprising a first threaded portion and a first stepped portion on an outer circumferential surface of the first lens barrel; and
a second lens barrel in which at least one lens is disposed and comprising a second threaded portion and a second stepped portion on an inner circumferential surface of the second lens barrel,
wherein the first stepped portion is inserted into the second stepped portion to align an optical axis of the at least one lens disposed in the first lens barrel with an optical axis of the at least one lens disposed in the second lens barrel, and
the first threaded portion is threaded into the second threaded portion and is rotatable relative to the second threaded portion to correct a focal length of the lens module.

17. The lens module of claim 16, wherein an outer diameter of the first stepped portion is small enough to enable the first stepped portion to be inserted into the second stepped portion, but large enough to enable an outer surface of the first stepped portion to contact an inner surface of the second stepped portion and maintain an alignment between the optical axis of the at least one lens disposed in the first lens barrel and the optical axis of the at least one lens disposed in the second lens barrel.

18. The lens module of claim 16, wherein the first stepped portion extends from a lower end of the first threaded portion toward a lower end of the first lens barrel in an optical axis direction of the lens module, and
the second stepped portion extends from a lower end of the second threaded portion toward a lower end of the second lens barrel in the optical axis direction.

19. The lens module of claim 18, wherein an outer diameter of the first stepped portion is smaller than an inner diameter of the second threaded portion and an inner diameter of the second threaded portion.

20. The lens module of claim 16, wherein the at least one lens disposed in the first lens barrel is a plurality of lenses each having a circular shape, and
the at least one lens disposed in the second lens barrel is a single lens having a D-cut shape.
